(19) United States
(12) Patent Application Publication
(10) Pub. No.: US 2024/0121668 A1
(43) Pub. Date: Apr. 11, 2024

(54) DYNAMIC TRANSMISSION BANDWIDTH CONTRACTS BETWEEN HUB AND SPOKE DEVICES

(71) Applicant: Hewlett Packard Enterprise Development LP, Houston, TX (US)

(72) Inventors: Gopalakrishnan Gunasekaran, Santa Clara, CA (US); Shreekanth Chandranna, Cupertino, CA (US); Naveed M. Shaik, San Jose, CA (US); Bhagvan B. Cheeyandira, San Jose, CA (US)

(21) Appl. No.: 17/961,347

(22) Filed: Oct. 6, 2022

(51) Int. Cl. H04W 28/20; H04W 28/02

(52) U.S. Cl. CPC H04W 28/20; H04W 28/0236

(57) ABSTRACT

One aspect can provide a system and method for configuring a plurality of branch gateway (BGW) devices coupled to a virtual private network concentrator (VPNC). The VPNC negotiates with a respective BGW device a transmission-bandwidth contract; receives, from the BGW device, a request for additional transmission bandwidth; analyzes traffic patterns to identify one or more BGW devices with unused bandwidth; allocates the requested additional transmission bandwidth to the respective BGW device by reducing transmission bandwidth allocated to the identified one or more BGW devices; and transmits contract-update notifications to the BGW devices to allow each BGW device to update a corresponding transmission-bandwidth contract, which comprises increasing the upper bandwidth limit at the respective BGW device while reducing the upper bandwidth limit at the identified BGW devices. In response to expiration of a timer, the VPNC revokes the additional transmission bandwidth allocated to the respective branch gateway device.

### BACKGROUND

### Field

This disclosure is generally related to communications between a central office and a number of branch offices coupled to the central office via tunnels. More specifically, this disclosure is related to allocating transmission bandwidth among branch gateway (BGW) devices coupled to a virtual private network concentrator (VPNC).

### BRIE DESCRIPTION OF THE FIGURES

FIG. 1 illustrates a wide area network (WAN) implementing dynamic transmission-bandwidth allocation among branch networks, according to one aspect of the application.

FIG. 2 illustrates the architecture of a branch gateway (BGW) device, according to one aspect of the application.

FIG. 3 illustrates the architecture of a concentrator device, according to one aspect of the application.

FIG. 4 presents a flowchart illustrating an exemplary dynamic bandwidth-allocation process, according to one aspect of the application.

FIG. 5 illustrates an exemplary computer system that facilitates dynamic allocation of transmission bandwidth among a plurality of branch networks, according to one aspect of the application.

In the figures, like reference numerals refer to the same figure elements.

### DETAILED DESCRIPTION

The following description is presented to enable any person skilled in the art to make and use the embodiments and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the scope of the present disclosure is not limited to the embodiments shown but is to be accorded the widest scope consistent with the principles and features disclosed herein.

Wide Area Networks (WANs) allow enterprises to extend their networks across different geographical locations by connecting branch networks to data centers in order to deliver applications and services required to perform a variety of functions. Enterprises with a large number of branch offices or sites can connect their branch networks to the central office (i.e., the data center) using virtual private network (VPN) tunnels over the Internet. The central office can be equipped with a VPN concentrator (VPNC) device, which is capable of establishing multiple encrypted VPN tunnels at the same time and can provide secure and encrypted connections among different VPN nodes. Each branch office can be equipped with one or more branch gateway (BGW) devices, which can function as network end points to connect client devices (e.g., laptop computers, smartphones, and Internet of Things (IoT) devices, etc.) at the branch office to servers (e.g., the data center) at the central office. For a large enterprise, one VPNC device at the central office may be connected to hundreds of BGW devices at different branch offices. If those hundreds of BGW devices simultaneously transmit large amounts of traffic to the VPNC device, the VPNC device may be overwhelmed, causing significant traffic loss. It is also possible that BGW devices at a particular branch office are transmitting data at higher rate, occupying the capacity of the VPNC device and causing traffic from other branch offices to be dropped. It is important to limit the amount of traffic transmitted by each BGW device to the VPNC device to ensure that there is fair data center access across all branch offices.

Transmission-bandwidth (TX-BW) contracts have been used as a mechanism to limit the amount of traffic transmitted from each BGW device at the branch offices to the concentrator device at the central office. More particularly, a user (e.g., a network administration) can configure the TX-BW contract at each BGW device to set an upper limit (e.g., a certain bits-per-second value) for the amount of traffic that can be transmitted by the BGW device. Traffic exceeding the limit set by the TX-BW contract will be dropped at the BGW device. In conventional approaches, the TX-BW contract configured at each BGW device is static. For example, the user may divide the total uplink bandwidth of the VPNC device evenly among all BGW devices coupled to the VPNC device and configure the TX-BW contract at the BGW device accordingly. Although applying the static TX-BW contract can prevent traffic loss at the VPNC device and can prevent the unfair distribution of the VPNC uplink bandwidth among the BGW devices, it has the drawback of underutilizing the VPNC bandwidth. This is because the traffic patterns of different BGW devices may be different, with some BGW devices having to drop traffic exceeding their TX-BW contract and other BGW devices not using 100% of their allocated transmission bandwidth. To optimize the bandwidth usage at the VPNC, according to some aspects, the TX-BW contract at each BGW device can be configured dynamically such that transmission bandwidth not used by one BGW device can be transferred to and used by other BGW devices needing additional transmission bandwidth.

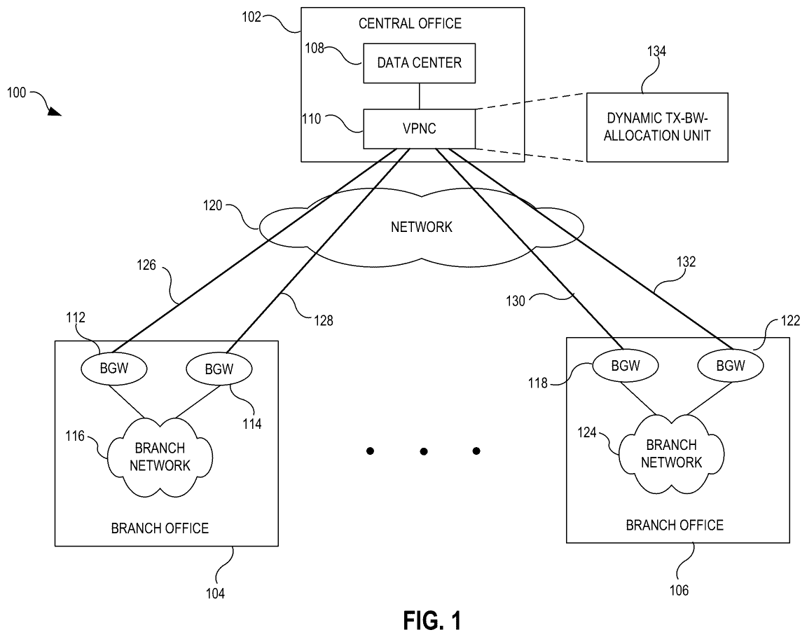

FIG. 1 illustrates a wide area network (WAN) implementing dynamic transmission-bandwidth allocation among branch networks, according to one aspect. WAN 100 can include a central office 102 and a number of branch offices (e.g., branch offices 104 and 106). Central office 102 can include one or more data centers that can be accessed by branch networks in branch offices 104 and 106 via corresponding concentrator devices over a network 120 (e.g., a public network). In the example shown in FIG. 1, central office 102 can include a data center 108 that can be accessed via a VPNC 110. It is possible that central office 102 includes multiple data centers, and that each data center can be accessed via multiple VPNCs.

Each branch office can include one or more BGW devices communicating with the concentrator devices at central office 102 via VPN tunnels. For example, branch office 104 can include a pair of BGW devices 112 and 114 for connecting branch network 116 to data center 108, and branch office 106 can include a pair of BGW devices 118 and 122 for connecting branch network 124 to data center 108. More specifically, BGW devices 112 and 114 can be connected to VPNC 110 via VPN tunnels 126 and 128, respectively; and BGW devices 118 and 122 can be connected to VPNC 110 via VPN tunnels 130 and 132, respectively. In this example, each branch office includes a pair of BGW devices to provide redundancy such that one failed BGW device does not result in the entire branch network losing connection to data center 108.

In each branch office, the BGW devices can function as network endpoints to connect client devices (not shown in FIG. 1) coupled to the branch network to data center 108 to facilitate those client devices in accessing services and resources provided by data center 108. The client devices can include but are not limited to: desktop computers, laptop computers, tablet computers, e-readers, netbook computers, televisions and similar monitors (e.g., smart TVs), content receivers, set-top boxes, personal digital assistants (PDAs), mobile phones, smartphones, smart terminals, dumb terminals, virtual terminals, video game consoles, virtual assistants, Internet of Things (IoT) devices, etc. A BGW device can be a router, a digital-to-analog modem, a cable modem, a digital subscriber line (DSL) modem, or other types of networking devices.

VPNC device 110 can be any hub-type networking device used for establishing and configuring the VPN tunnels (e.g., tunnels 126-132) between VPNC device 110 and the BGW devices (e.g., BGW devices 112, 114, 118, and 122) over network 120. According to some aspects, VPNC device 110 can be a router. The VPN tunnels can be established according to the Internet Protocol Security (IPSec) protocol. To optimize the bandwidth utilization at VPNC device 110, VPNC device 110 can include a dynamic transmission-bandwidth (TX-BW)-allocation unit 134 responsible for allocating transmission bandwidth to BGW devices coupled to VPNC device 110 via the VPN tunnels.

The TX-BW contract at a BGW device can be obtained as part of the tunnel-negotiation process between the BGW device and the VPNC device. Before the tunnel is established, both the BGW and the VPNC can receive configuration parameters from a configuration service, which can be provided by a standalone configuration server or a cloud-based configuration server. The configuration parameters can include a TX-BW contract, which sets the upper limit of the TX-BW for each BGW device. The TX-BW contract of the tunnel can be negotiated between the endpoints (or peers) of the tunnel based on their configured TX-BW contract. Using IPSec VPN tunnels as an example, the TX-BW contract can be obtained using a VPN negotiation process, during which the IPSec peers exchange a series of messages about encryption and authentication and attempt to agree on many different parameters (which can include the transmission bandwidth). According to some aspects, the BGW device can be the initiator for tunnel negotiation and the VPNC device can be the responder. The negotiation process can be triggered via Internet Key Exchange (IKE) vendor ID payloads or, in the case of orchestrated tunnels, via probe exchanges between the BGW device (e.g., the initiator) and the VPNC device (e.g., the responder). The negotiated TX-BW contract of a VPN tunnel typically is the lowest bandwidth configured on the BGW device and the VPNC device. For example, if a BGW device is configured at 100 Gbps and the VPNC device is configured at 50 Gbps, then after negotiation, both the BGW device and the VPNC device can configure their negotiated TX-BW contract for the tunnel as 50 Gbps. Traffic exceeding the TX-BW contract will be dropped.

In conventional approaches, once the TX-BW contract is negotiated for each tunnel or BGW device, it remains unchanged regardless of the traffic pattern at the BGW device. For example, if the negotiated TX-BW contract is 50 Gbps, the BGW device can only transmit at a rate of 50 Gbps or lower to the VPNC device, even if the BGW device has more than 50 Gb of data to be sent in one second. Packets exceeding the 50 Gbps limit will be dropped by the BGW device. This may result in the underutilization of the VPNC's capacity, especially for a VPNC coupled to a large number of BGW devices. In one example, the VPNC has an uplink (i.e., the link connected to the network) capacity of 1000 Gbps and is coupled to 20 BGW devices. The VPNC may evenly divide its uplink bandwidth among all BGW devices by allocating 50 Gbps to each BGW device. If each BGW is configured at 50 Gbps or higher, the negotiated TX-BW contract for each tunnel will be 50 Gbps. Once the TX-BW contract is negotiated, a BGW device cannot transmit to the VPNC at a bandwidth higher than the negotiated TX-BW contract, although the BGW device may receive more traffic from the branch network while other BGW devices may not use all of their allocated bandwidth. In the above example, one of the 20 BGW devices may receive 100 Gbps traffic from the coupled branch network but will have to drop 50 Gbps traffic, even if the other 19 BGW devices are all transmitting at a rate much lower than the allowed rate of 50 Gbps (e.g., each of the other BGW devices may transmit at 10 Gbps). Consequently, the total bandwidth usage at the VPNC device will be 240 Gbps, which is much lower than the 1000 Gbps bandwidth capacity of the VPNC device.

In contrast, the proposed dynamic TX-BW-allocation approach allows the TX-BW contract to be dynamically updated, based on traffic patterns at the BGW devices, such that a high-traffic BGW device may be allocated with additional bandwidth not used by other low-traffic BGW devices to prevent traffic loss at the high-traffic BGW device. In the above example, when a particular BGW device has 100 Gbps traffic to send to the VPNC device, instead of having to drop the traffic exceeding the TX-BW contract of 50 Gbps, this particular BGW can request more bandwidth from the VPNC device. The VPNC device can analyze traffic patterns on other BGW devices and determine that the other BGW devices have unused bandwidth. In response, the VPNC device can reconfigure the TX-BW contracts of the BGW devices by increasing the value of the TX-BW contract at the requesting BGW device while decreasing the value of the TX-BW contract at one or more other BGW devices. In the above example, the TX-BW contract of the requesting BGW device can be reconfigured to be 100 Gbps, and the TX-BW contract of two other BGW devices can be reconfigured to be 25 Gbps. The total bandwidth usage at the VPNC device remains unchanged, and no traffic is dropped at the BGW devices. Because traffic patterns on the branch networks can change dynamically (e.g., the BGW device requesting the additional bandwidth may no longer need the additional bandwidth after transmitting at the higher rate for a certain duration, or the other two BGW devices with the reduced TX-BW contract value may require more bandwidth later), those newly configured TX-BW contracts can be configured to expire after a predetermined time period. Once expired, the TX-BW contract on the BGW device can be reset (e.g., reconfigured) to its initial value negotiated between the VPNC device and the BGW device.

According to some aspects, the TX-BW contract can be expressed in the form of bandwidth credits, with each credit representing a predetermined amount of bandwidth. For example, one credit may represent 1 Gbps or 100 Mbps, or other bits-per-second (bps) values, depending on the implementation. Each BGW device can be allocated with an initial number of credits (e.g., through the tunnel negotiation process). When one BGW device has more data to send than what is allowed by the TX-BW contract (i.e., when it runs out of credit), the BGW device can request, from the VPNC device, more credits. In response to the request, the VPNC device can analyze traffic patterns in all tunnels (or on all BGW devices) to determine if there are enough credits to meet the request (i.e., if the number of credits not used by other BGW devices is equal to or greater than the requested credits). If so, the request can be granted, and the VPNC device can increase the number of credits allocated to the requesting BGW device by transferring unused credits from other BGW devices. More specifically, the VPNC device can reconfigure the TX-BW contract on all affected BGW devices, including the BGW device requesting more credits and other BGW devices that have their initial credits reduced. If there are not enough credits, the request may be denied. According to alternative aspects, even if there are not enough credits to meet the request from the BGW device, the VPNC device can still allocate additional credits to the requesting BGW device to reduce the amount of traffic being dropped at the requesting BGW device. The transferred credits have an expiration time. Once expired, they will be transferred back to their previous owner (i.e., the TX-BW contract on each BGW device will be reset to its initial value). In addition, the previous owner of the transferred credits may also revoke the credits before their expiration.

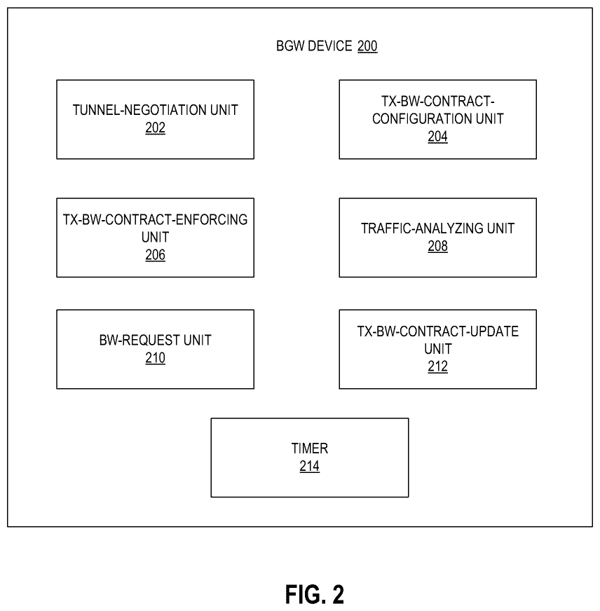

FIG. 2 illustrates the architecture of a branch gateway (BGW) device, according to one aspect. As discussed previously, BGW device 200 can be a switch or a router. BGW device 200 can include a tunnel-negotiation unit 202, a TX-BW-contract-configuration unit 204, TX-BW-contract-enforcing unit 206, a traffic-analyzing unit 208, a BW-request unit 210, a TX-BW-contract-update unit 212, and a timer 214. In addition to the above functional units, BGW device 200 can also include other types of functional units responsible for performing standard BGW functions, such as forwarding traffic between the branch network and the data center at the central office, performing security (e.g., encryption/decryption) operations, etc. These additional functional units will not be described in detail here, because they do not pertain to the dynamic allocation of the transmission bandwidth.

Tunnel-negotiation unit 202 can be responsible for negotiating, with the VPNC device at the other end of the VPN tunnel, a set of tunnel parameters. Tunnel-negotiation unit 202 can exchange, via a transceiver (not shown in FIG. 2) on BGW device 200, messages with a corresponding tunnel-negotiation unit on the VPNC device. According to some aspects, BGW device 200 and the VPNC device can be IPSec peers, and tunnel-negotiation unit 202 can negotiate tunnel parameters according to the IPSec protocol.

TX-BW-contract-configuration unit 204 can be responsible for configuring the initial TX-BW contract on BGW device 200. According to some aspects, TX-BW-contract-configuration unit 204 can receive, from a configuration service, the TX-BW contract for BGW device 200. The configuration service can reside on a configuration server, and a network administrator can input the TX-BW contract for BGW device 200 to the configuration server manually (e.g., via a user interface associated with the configuration server). In addition to a standalone configuration server, a cloud-based server can also provide the configuration service. The TX-BW contract can be in the form of bps (e.g., 50 Gbps) or in the form of credits (e.g., 50 credits). The configured TX-BW contract can then be used by tunnel-negotiation unit 202 to negotiate the TX-BW contract for the tunnel, which is typically the lowest bandwidth configured at BGW device 200 and the VPNC device. For example, if the TX-BW contract configured at the BGW device 200 is 100 Gbps, and the TX-BW contract configured at the VPNC device is 50 Gbps, the negotiated TX-BW contract for the tunnel will be set as 50 Gbps. TX-BW-contract-enforcing unit 206 can be responsible for enforcing the negotiated TX-BW contract. More specifically, TX-BW-contract-enforcing unit 206 can drop packets exceeding the bandwidth specified by the negotiated TX-BW contract.

Traffic-analyzing unit 208 can be responsible for monitoring traffic at BGW device 200 to determine whether additional bandwidth should be allocated to BGW device 200. According to some aspects, traffic-analyzing unit 208 can determine whether BGW device 200 is experiencing traffic loss due to the limit of the TX-BW contract and, if so, can determine the duration of the traffic loss. For example, traffic-analyzing unit 208 can determine that TX-BW-contract-enforcing unit 206 has been dropping packets exceeding the limit set by the TX-BW contract for a duration of 30 seconds or one minute. In response to determining that the duration of the traffic loss resulting from the TX-BW contract exceeds a predetermined threshold (e.g., 30 seconds or one minute), traffic-analyzing unit 208 can send a signal to BW-request unit 210, triggering BW-request unit 210 to send a BW-request message to the VPNC device, requesting more TX-BW or credits to be allocated to BGW device 200. Note that the requested amount of bandwidth or number of credits can be determined or estimated based on the amount of traffic being dropped. For example, if traffic-analyzing unit 208 determines that TX-BW-contract-enforcing unit 206 has been dropping packets at a rate of 1 Gbps, BW-request unit 210 can request 1 Gbps of additional bandwidth or one more credit.

According to some aspects, the BW-request message can be an IPSec Encapsulating Security Payload (ESP) probe request frame with a special opcode (e.g., a vendor-defined opcode), indicating that the probe request is a request for more bandwidth or credits. BW-request unit 210 can further be responsible for receiving a corresponding response message from the VPNC device. If the BW-request message is an IPSec ESP probe request frame, the corresponding response message can be an IPSec ESP probe response frame. Both the probe request and the probe response can have the same special opcode to indicate that the message is for requesting more bandwidth/credits or for responding to the request for more bandwidth/credits. Note that the response message may indicate the amount of additional bandwidth or the number of additional credits to be allocated the BGW device 200.

TX-BW-contract-update unit 212 can update the TX-BW contract for BGW device 200 based on the response message received from the VPNC device. For example, if the response message indicates that an additional amount of bandwidth or an additional number of credits has been allocated to BGW device 200, TX-BW-contract-update unit 212 can update the TX-BW contract for BGW device 200 accordingly. Once the TX-BW contract is updated, TX-BW-contract-enforcing unit 206 can enforce the updated TX-BW contract (e.g., only drop packets that exceed the updated TX-BW contract). According to some aspects, when TX-BW-contract-update unit 212 updates the TX-BW contract, timer 214 (which is set to a predetermined stating value) is trigger. Once timer 214 expires, TX-BW-contract-update unit 212 can reset the TX-BW contract to its original value. In other words, the updated TX-BW contract has a predetermined lifetime. This can ensure that BGW 200 does not occupy the additional bandwidth for an extended period. According to some aspects, the predetermined lifetime of the updated TX-BW contract can be between 10 and 30 minutes (e.g., 15 minutes). Before the expiration of timer 214, the updated TX-BW contract may also be reset (or be replaced by the original, negotiated TX-BW contract) when the additional BW or credits are revoked by their previous owner. Note that the VPNC device allocates additional bandwidth/credits to BGW device 200 by reducing the bandwidth/credits allocated to other BGW devices. Hence, if the other BGW devices are experiencing a traffic surge and requesting their fair share of the bandwidth at the VPNC device, the VPNC device can return the bandwidth to those BGW devices by revoking the additional bandwidth temporarily allocated to BGW device 200.

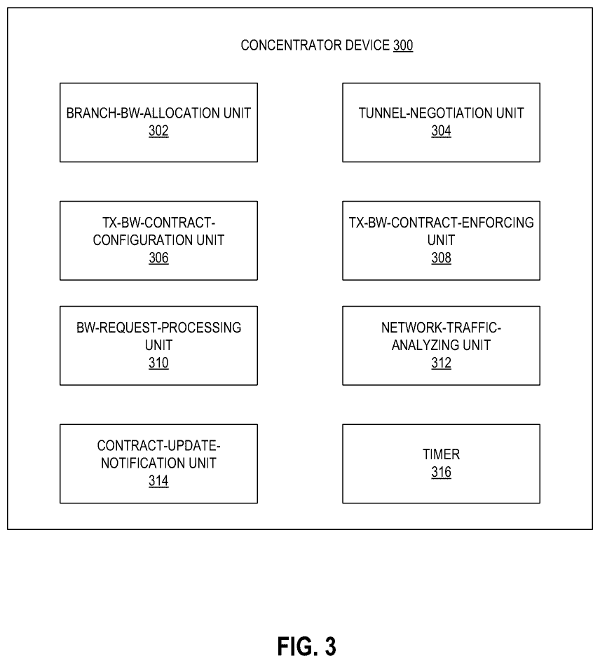

FIG. 3 illustrates the architecture of a concentrator device, according to one aspect. A concentrator device (e.g., a VPNC) 300 can be a hub-type networking device (e.g., a router) and can include a branch-BW-allocation unit 302, a tunnel-negotiation unit 304, a TX-BW-contract-configuration unit 306, a TX-BW-contract-enforcing unit 308, a BW-request-processing unit 310, a network-traffic-analyzing unit 312, a contract-update-notification unit 314, and a timer 316. Note that concentrator device 300 can also include additional functional units responsible for performing functions related to establishing and maintaining multiple tunnels and for forwarding traffic between the tunnels and the data center. These additional functional units will not be described in detail here, because they do not pertain to dynamic allocation of bandwidth among multiple BGW devices.

Branch-BW-allocation unit 302 can be responsible for allocating the uplink (i.e., the link to the network) bandwidth of concentrator device 300 among a plurality of BGW devices. According to some aspects, the uplink bandwidth of concentrator device 300 can be evenly distributed across the BGW devices. According to alternative aspects, the uplink bandwidth of concentrator device 300 can be distributed across the BGW devices based on the priority rankings of those BGW devices, with larger bandwidth being allocated to higher-ranking BGW devices.

Tunnel-negotiation unit 304 can participate in the tunnel-negotiation process with tunnel-negotiation unit 202 of BGW device 200, which is shown in FIG. 2. TX-BW-contract-configuration unit 306 can be similar to TX-BW-contract-configuration unit 204 shown in FIG. 2 and can similarly receive, from a configuration service, the initial TX-BW contract for concentrator device 300. Note that the TX-BW contract for concentrator device 300 can specify the TX-BW contract allocated for each coupled BGW device. TX-BW-contract-configuration unit 306 can configure the TX-BW contract for concentrator device 300 based on the received configuration. The configured TX-BW contract can then be used by tunnel-negotiation unit 304 during the tunnel-negotiation process to determine the negotiated TX-BW contract for the tunnel. TX-BW-contract-enforcing unit 308 can enforce the TX-BW contract such that concentrator device 300 does not transmit to a particular tunnel at a rate higher than the negotiated TX-BW contract for that tunnel.

BW-request-processing unit 310 can receive and process the BW-request messages received from the BGW devices. A BW-request message can be in the form of an IPSec ESP probe request with a special opcode. In response to detecting the special opcode, BW-request-processing unit 310 can extract, from the BW-request message, the amount of bandwidth or the number of credits requested by the sending BGW device. Network-traffic-analyzing unit 312 can be responsible for analyzing the traffic patterns on all tunnels coupled to concentrator device 300. According to some aspects, network-traffic-analyzing unit 312 can determine, for each tunnel or for each coupled BGW device, the average bandwidth usage within a certain time window. Due to the dynamic nature of the traffic pattern in the branch network throughout the workday (e.g., typically there is more traffic in the morning hours), the duration of time window is preferred to be no more than a few hours. In one example, the time window can have a predetermined duration of 30 minutes. By monitoring the average bandwidth usage within the time window, network-traffic-analyzing unit 312 can determine whether a particular BGW device is underutilizing its allocated bandwidth. If so, the bandwidth allocation for that particular BGW device can be reduced and the extra bandwidth can be allocated to other BGW device(s) request more of the uplink bandwidth of concentrator device 300. Network-traffic-analyzing unit 312 can monitor the traffic patterns in the tunnels continuously, and in some cases, the time window can be a sliding time window. Alternatively, network-traffic-analyzing unit 312 can monitor the traffic patterns in the tunnels periodically or on demand. For example, network-traffic-analyzing unit 312 can monitor the traffic patterns every 10 minutes or in response to BW-request-processing unit 310 receiving a BW-request message.

The traffic-pattern analyzing result can be sent to branch-BW-allocation unit 302 that can dynamically allocate additional bandwidth to a BGW device request more bandwidth. More specifically, branch-BW-allocation unit 302 can reduce the bandwidth or credit allocation for BGW device(s) that did not use all of their previously allocated bandwidth/credits and increase the bandwidth/credit allocation for the BGW device request more bandwidth/credits. When dynamically allocating the bandwidth not used by certain BGW devices to a BGW device request more bandwidth, branch-BW-allocation unit 302 can apply different strategies, depending on the implementation. According to some aspects, branch-BW-allocation unit 302 can provide additional bandwidth to the requesting BGW device by involving a minimum number of other BGW devices. For example, if a BGW device is request X additional credits, branch-BW-allocation unit 302 can determine, based on the traffic-analyzing result provided by network-traffic-analyzing unit 312, whether there are X unused credits in the network and, if so, the minimum number of BGW devices needed to provide the X unused credits. In an ideal situation, in addition to the requesting BGW device, only one other BGW device would be involved in the dynamic bandwidth allocation (i.e., the number of credits not used by the other BGW device can meet the request of the additional credits from the requesting BGW device). In cases where no single BGW device can provide enough unused credits, branch-BW-allocation unit 302 can select the most underutilized BGW devices such that the total number of BGW devices involved in the dynamic bandwidth-allocation process can be minimized. The advantage of this approach is that a minimum number of BGW devices will be affected by this process and a minimum number of messages are exchanged between concentrator device 300 and the BGW devices. According to alternative aspects, branch-BW-allocation unit 302 can provide additional bandwidth to the requesting BGW device by minimizing the bandwidth reduction on other BGW devices. For example, if a BGW device is request X additional credits, branch-BW-allocation unit 302 can divide the X credits among all underutilized BGW devices, such that the reduction of the TX-BW contract on each underutilized BGW device can be minimized. The advantage of this approach is that the effect on each BGW device remains minimal, and it is less likely that the dynamically allocated bandwidth will be revoked during its lifetime. In one more example, the bandwidth reduction on each BGW device can be proportional to the unused bandwidth.

According to some aspects, the lifetime of the dynamically allocated bandwidth depends on the time window used by network-traffic-analyzing unit 312 for analyzing the traffic pattern in each tunnel. This is because the duration of the time window can provide a statistical estimation of the duration of the current traffic pattern. For example, if a tunnel underutilized its allocated bandwidth in the last 30 minutes, it is very likely that it will continue to underutilize its bandwidth in the next 10 to 15 minutes. Accordingly, the bandwidth not used by this BGW device can be allocated to other BGW devices during the next 10 to 15 minutes. In one example, the lifetime of the dynamically allocated bandwidth (i.e., the initial setting of timer 214 in FIG. 2) can be between 20% and 60% of the duration of the time window used by network-traffic-analyzing unit 312 for analyzing the traffic patterns. In one example, the time window can be approximately 30 minutes, and the lifetime of the dynamically allocated bandwidth or credits can be approximately 15 minutes.

Contract-update-notification unit 314 can be responsible for sending notification to BGW devices such that the BGW devices can update the values of their TX-BW contracts. The TX-BW contract at concentrator device 300 is updated similarly. According to some aspects, contract-update-notification unit 314 can send IPSec probe response messages to all involved BGW devices, including the BGW device request more bandwidth and the BGW device(s) with their current TX-BW contract reduced. The IPSec probe response message targeting a BGW device can include information indicating the amount of bandwidth or the number of credits to be increased or reduced at the BGW device. Timer 316 can be used to track the lifetime of the dynamically allocated bandwidth or credits. According to some aspects, timer 316 can track the lifetime of the dynamic bandwidth for each BGW device. When timer 316 of a particular BGW device expires, the TX-BW contract for that BGW device on concentrator 300 is reset to its original value. In addition to resetting the TX-BW contract on concentrator device 300, the expiration of timer 316 can also trigger contract-update-notification unit 314 to send notifications to BGW devices to instruct the BGW devices to reset their TX-BW contract. According to alternative aspects, each BGW device maintains a timer to track the lifetime of the dynamic bandwidth allocation, and there is no need for contract-update-notification unit 314 to send separate notifications.

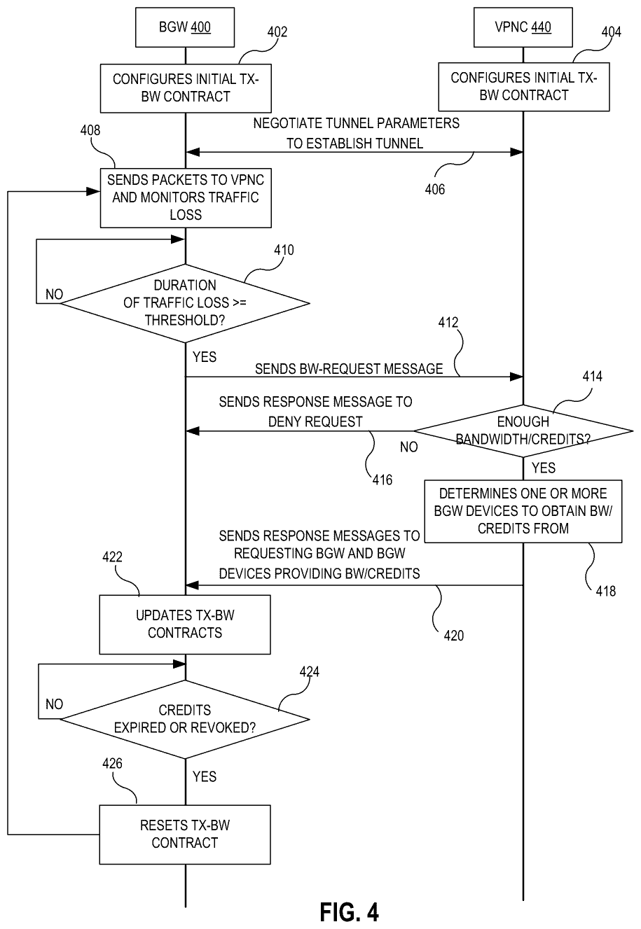

FIG. 4 illustrates an exemplary dynamic bandwidth-allocation process, according to one aspect. During operation, each of the tunnel initiator (e.g., a BGW device 400) and the responder (e.g., a VPNC device 440) can be configured with an initial TX-BW contract (operation 402 and operation 404). More specifically, each device can receive configuration parameters from a configuration service and use the received parameters to configure the initial TX-BW contract. BGW device 400 and VPNC device 440 can negotiate tunnel parameters to establish a tunnel (operation 406). The negotiated tunnel parameters can include the negotiated TX-BW contract for the tunnel, which can be the lowest TX-BW contract initially configured on BGW device 400 and the VPNC device 440. The negotiated TX-BW contract is the TX-BW contract applied at BGW device 400 and VPNC device 440.

Subsequent to the establishment of the tunnel, BGW device 400 can send packets to VPNC device 440 and monitor traffic loss (operation 408). As discussed previously, the negotiated TX-BW contract sets an upper limit for the data rate at which BGW device 400 can transmit to VPNC device 440. Traffic exceeding the TX-BW contract is dropped at BGW device 400. BGW device 400 can determine whether the duration of the traffic loss due to the limit set by the negotiated TX-BW contract equals or is greater than a predetermined threshold (operation 410). According to some aspects, the predetermined threshold for traffic-loss duration can be between 30 seconds and a few minutes (e.g., one or two minutes).

If the traffic loss lasts less than the predetermined duration, BGW device 400 continues to monitor the traffic loss (operation 410); otherwise, BGW device 400 can send a BW-request message to VPNC device 440 (operation 412). According to some aspects, the BW-request message can be an IPSec ESP probe request message with a special opcode and can include information regarding the requested amount of additional bandwidth or number of credits computed based on the rate of traffic loss at the BGW device. If BGW device 400 is losing traffic at a rate of 1 Gbps, the IPSec ESP probe request message can indicate in its payload that 1 Gbps of additional bandwidth is requested.

Upon receiving the BW-request message, VPNC device 440 can determine, based on the traffic patterns of all tunnels coupled to VPNC device 440, whether there is enough unused bandwidth or credits available (operation 414). More specifically, VPNC device 440 can analyze the traffic patterns within a time window of a predetermined size to determine whether its uplink bandwidth unused by other BGW devices can meet the request. The length of the time window can be between 30 minutes and a few hours. If there is not sufficient bandwidth/credits, the request is denied and VPNC device 440 can send a response message to BGW device 400 (operation 416). If there are sufficient credits, VPNC device 440 can identify one or more BGW devices from which the bandwidth/credits can be obtained (operation 418). In other words, VPNC device 440 can identify one or more BGW devices that are underutilizing their bandwidth allocation and then reduce their bandwidth allocation according to the BW-request message. VPNC device 440 may select a minimum number of BGW devices to meet the bandwidth request or VPNC device 440 may minimize the bandwidth reduction on each BGW device. In situations where VPNC device 440 receives multiple BW-request messages from multiple BGW devices, VPNC device 440 may allocate additional bandwidth to a BGW device with the highest priority.

VPNC device 440 can subsequently send response messages to both BGW device 400 that requests the bandwidth/credits and the BGW device(s) providing the bandwidth/credits (operation 420). The response messages can be IPSec ESP probe response messages. The response message to the requesting BGW device 400 can indicate to BGW device 400 that the request for additional bandwidth/credits has been granted. The response message to a BGW device providing unused bandwidth can indicate to the BGW device that its TX-BW contract has been reduced. Upon receiving the response messages, the BGW devices (including the requesting BGW device 400 and other affected BGW devices) can update their TX-BW contract accordingly (operation 422). Updating the TX-BW contract can allow the requesting BGW device 400 to transmit at a higher rate. Note that because the other BGW devices are expected to transmit at a rate lower than their original TX-BW contract, the reduced TX-BW contract typically does not affect their behavior.

BGW device 400 can subsequently determine whether the newly allocated bandwidth/credits have expired or are revoked (operation 424). If so, BGW device 400 can reset its TX-BW contract to the original, negotiated value (operation 426) and continue to monitor the traffic to determine if more bandwidth/credits would be needed (operation 408). Otherwise, BGW device 400 can wait for the newly allocated bandwidth/credits to expire or be revoked (operation 424). According to some aspects, the lifetime of the newly allocated bandwidth/credits can be determined based on the time window used by VPNC device 440 for analyzing traffic patterns in all of the coupled tunnels. The lifetime of the newly allocated bandwidth/credits can be between 20% and 60% of the time window. In one example, the time window can be approximately 30 minutes, and the lifetime of the newly allocation bandwidth can be approximately 15 minutes.

In the example shown in FIG. 4, the VPNC denies the request from a BGW device if the requested bandwidth exceeds the unused uplink bandwidth of the VPNC device. According to alternative aspects, instead of denying the request, the VPNC may partially fulfill the request by providing unused bandwidth to the requesting BGW device, even though the provided bandwidth is less than the requested bandwidth.

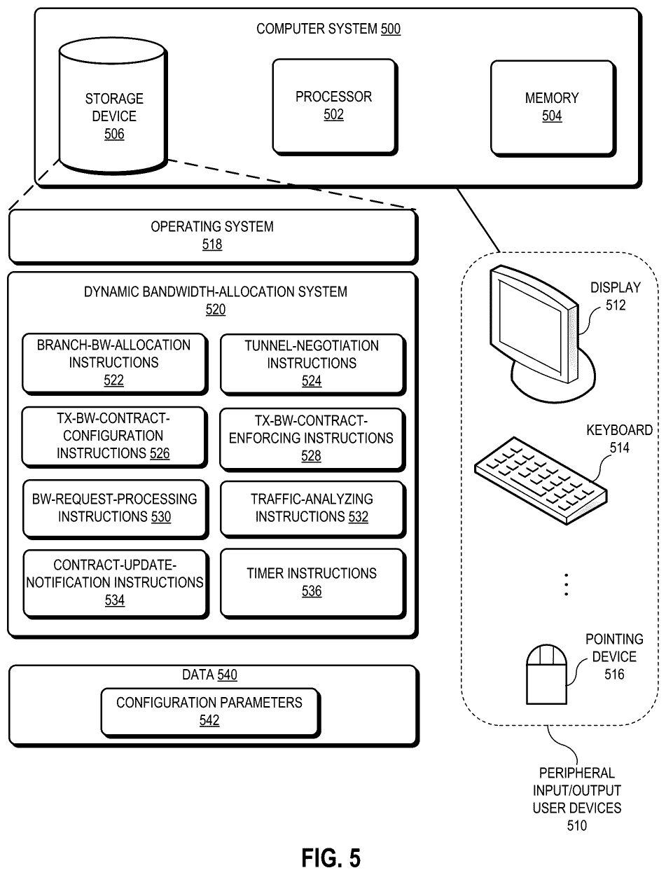

FIG. 5 illustrates an exemplary computer system that facilitates dynamic allocation of transmission bandwidth among a plurality of branch networks, according to one aspect of the application. Computer system 500 can include a processor 502, a memory 504, and a storage device 506. Furthermore, computer system 500 can be coupled to peripheral input/output (I/O) user devices 510, e.g., a display device 512, a keyboard 514, and a pointing device 516. Storage device 506 can store an operating system 518, a dynamic bandwidth-allocation system 520, and data 540. According to some aspects, computer system 500 can be part of a network hub device (e.g., a VPNC). Computer system 500 can also be part of a network spoke device (e.g., a BGW device).

Dynamic bandwidth-allocation system 520 can include instructions, which when executed by computer system 500, can cause computer system 500 or processor 502 to perform methods and/or processes described in this disclosure. Specifically, dynamic bandwidth-allocation system 520 can include instructions for allocating bandwidth among branch networks (branch-BW-allocation instructions 522), instructions for negotiating tunnel parameters with BGW devices (tunnel-negotiation instructions 524), instructions for receiving TX-BW configuration and for configuring the initial TX-BW contract (TX-BW-contract-configuration instructions 526), instructions for enforcing the negotiated tunnel TX-BW contract (TX-BW-contract-enforcing instructions 528), instructions for receiving and processing BW-request messages from BGW devices (BW-request-processing instructions 530), instructions for analyzing traffic patterns in all tunnels (traffic-analyzing instructions 532), instructions for generating and sending contract-update notifications to BGW devices (contract-update-notification instructions 534), and instructions for implementing a timer (timer instructions 536). Data 540 can include configuration parameters 542 received from the configuration service.

In general, the disclosure provides a solution to the problem of inefficient usage of the uplink bandwidth of a concentrator device coupled to a plurality of BGW devices. Compared with conventional approaches where the TX-BW contract at each BGW device is static, the proposed solution allows the concentrator device to dynamically update the TX-BW contract at each BGW device based on traffic patterns in all tunnels. The VPNC and each BGW device can be configured with an initial TX-BW contract, specifying the bandwidth allocated for each BGW device. When a BGW device experiences packet loss due to the limit set by the TX-BW contract for a predetermined time period, the BGW device can request more bandwidth from the VPNC. The VPNC analyzes the traffic pattern on all BGW devices within a predetermined time window to determine a number of BGW devices that underutilize their allocated bandwidth. In response, the VPNC can allocate more bandwidth to the requesting BGW device by reducing the bandwidth allocated to those identified underutilizing BGW devices. The VPNC can send contract-update notifications to both the requesting BGW device and the identified underutilizing BGW devices to update their TX-BW contracts accordingly. These newly updated TX-BW contracts expire after a predetermined time interval, and the TX-BW contracts on the BGW devices can be reset to their original contract values. Moreover, the newly updated TX-BW contracts can be revoked, if one or more BGW devices are experiencing a traffic surge and request their TX-BW contract to be reinstated to its original value.

One aspect can provide a system and method for configuring a plurality of branch gateway devices located at branch offices coupled to a virtual private network (VPN) concentrator located at a central office. During operation, the VPN concentrator can negotiate with a respective branch gateway device a transmission-bandwidth contract that specifies an upper bandwidth limit for the respective branch gateway device to transmit data to the VPN concentrator; receive, from the respective branch gateway device, a request for additional transmission bandwidth and analyze traffic patterns associated with the plurality of branch gateway devices to identify one or more branch gateway devices with unused transmission bandwidth according to corresponding transmission-bandwidth contracts; allocate the requested additional transmission bandwidth to the respective branch gateway device by reducing transmission bandwidth allocated to the identified one or more branch gateway devices by an amount corresponding to the requested additional transmission bandwidth; and transmit contract-update notifications to the respective branch gateway device and the identified one or more branch gateway devices to allow each branch gateway device to update a corresponding transmission-bandwidth contract, which comprises increasing the upper bandwidth limit at the respective branch gateway device while reducing the upper bandwidth limit at the identified one or more branch gateway devices. In response to expiration of a predetermined timer, the VPN concentrator can revoke the additional transmission bandwidth allocated to the respective branch gateway device by replacing, at the respective branch gateway device, the updated transmission-bandwidth contract with the negotiated transmission-bandwidth contract.

In a variation on this aspect, the request for the additional transmission bandwidth can include a request for a corresponding number of transmission credits, with one transmission credit corresponding to a predetermined amount of transmission bandwidth.

In a variation on this aspect, the method can further include discarding, at the respective branch gateway device, traffic exceeding the upper bandwidth limit specified by the transmission-bandwidth contract to cause traffic loss at the respective branch gateway device; in response to determining that the respective branch gateway device has experienced traffic loss for a predetermined duration, estimating an amount of additional transmission bandwidth needed to prevent the traffic loss; and transmitting, by the respective branch gateway device to the VPN concentrator, a request for the estimated amount of additional transmission bandwidth.

In a further variation, identifying one or more branch gateway devices with unused transmission bandwidth can include identifying a minimum number of branch gateway devices that can provide the estimated amount of additional transmission bandwidth.

In a variation on this aspect, analyzing the traffic patterns can include determining, for each branch gateway device, an average transmission bandwidth usage within a predetermined time window; and identifying the one or more branch gateway devices with unused transmission bandwidth can include comparing the average transmission bandwidth usage of each branch gateway device with a corresponding transmission-bandwidth contract.

In a further variation, a duration of the predetermined time window is between 30 minutes and one hour.

In a further variation, the predetermined timer expires after a duration that is between 20% and 60% of a duration of the time window.

In a variation on this aspect, the respective branch gateway device can be coupled to the VPN concentrator via an Internet Protocol Security (IPSec)-based VPN tunnel.

In a further variation, the request for additional transmission bandwidth can include an IPSec Encapsulating Security Payload (ESP) probe request frame, and a respective contract-update notification can include an IPSec ESP probe response frame.

In a further variation, the IPSec ESP probe request or response frame can include a vendor-defined special opcode.

One aspect can provide a branch gateway device coupled to a virtual private network (VPN) concentrator via a VPN tunnel. The branch gateway device can include a tunnel-negotiation unit to negotiate, with the VPN concentrator, a transmission-bandwidth contract specifying an upper bandwidth limit for the branch gateway device to transmit data to the VPN concentrator via the VPN tunnel; a traffic-analyzing unit to analyze traffic on the branch gateway device to determine whether additional transmission bandwidth is needed; and a bandwidth-request unit to, in response to the traffic-analyzing unit determining that additional transmission bandwidth is needed, send a request to the VPN concentrator for additional transmission bandwidth. The request can cause the VPN concentrator to analyze traffic patterns associated with a plurality of branch gateway devices coupled to the VPN concentrator to identify one or more branch gateway devices with unused transmission bandwidth and to allocate the requested additional transmission bandwidth to the branch gateway device by reducing transmission bandwidth allocated to the identified one or more branch gateway devices by an amount corresponding to the requested additional transmission bandwidth. The branch gateway device can include a contract-update unit to update the transmission-bandwidth contract in response to receiving a response from the VPN concentrator, thereby increasing the upper bandwidth limit. The branch gateway device can further include a timer. Expiration of the timer can cause the contract-update unit to replace the updated transmission-bandwidth contract with the negotiated transmission-bandwidth contract, thereby revoking the additional transmission bandwidth allocated to the branch gateway device.

One aspect can provide a virtual private network (VPN) concentrator coupled to a plurality of branch gateway devices. The VPN concentrator can include a tunnel-negotiation unit to negotiate, with a respective branch gateway device, a transmission-bandwidth contract that specifies an upper bandwidth limit for the respective branch gateway device to transmit data to the VPN concentrator; a request-receiving unit to receive, from the respective branch gateway device, a request for additional transmission bandwidth; a traffic-analyzing unit to analyze traffic patterns associated with the plurality of branch gateway devices to identify one or more branch gateway devices with unused transmission bandwidth according to corresponding transmission-bandwidth contracts; a bandwidth-allocation unit to allocate the requested additional transmission bandwidth to the respective branch gateway device by reducing transmission bandwidth allocated to the identified one or more branch gateway devices by an amount corresponding to the requested additional transmission bandwidth; a contract-update-notification unit to transmit contract-update notifications to the respective branch gateway device and the identified one or more branch gateway devices to allow each branch gateway device to update a corresponding transmission-bandwidth contract, which comprises increasing the upper bandwidth limit at the respective branch gateway device while reducing the upper bandwidth limit at the identified one or more branch gateway devices; and a timer, expiration of the timer causing the respective branch gateway device to replace the updated transmission-bandwidth contract with the negotiated transmission-bandwidth contract to revoke the additional transmission bandwidth allocated to the respective branch gateway device.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing descriptions of embodiments have been presented for purposes of illustration and description only. They are not intended to be exhaustive or to limit the scope of this disclosure to the forms disclosed. Accordingly, many modifications and variations will be apparent to practitioners skilled in the art.

What is claimed is:

1. A method for configuring a plurality of branch gateway devices located at branch offices coupled to a virtual private network (VPN) concentrator located at a central office, the method comprising:
negotiating, by the VPN concentrator with a respective branch gateway device, a transmission-bandwidth contract for the respective branch gateway device, wherein the transmission-bandwidth contract specifies an upper bandwidth limit for the respective branch gateway device to transmit data to the VPN concentrator;
receiving, from the respective branch gateway device, a request for additional transmission bandwidth;
analyzing, by the VPN concentrator, traffic patterns associated with the plurality of branch gateway devices to identify one or more branch gateway devices with unused transmission bandwidth according to corresponding transmission-bandwidth contracts;
allocating the requested additional transmission bandwidth to the respective branch gateway device by reducing transmission bandwidth allocated to the identified one or more branch gateway devices by an amount corresponding to the requested additional transmission bandwidth;
transmitting contract-update notifications to the respective branch gateway device and the identified one or more branch gateway devices to allow each branch gateway device to update a corresponding transmission-bandwidth contract, which comprises increasing the upper bandwidth limit at the respective branch gateway device while reducing the upper bandwidth limit at the identified one or more branch gateway devices; and
in response to expiration of a predetermined timer, revoking the additional transmission bandwidth allocated to the respective branch gateway device by replacing, at the respective branch gateway device, the updated transmission-bandwidth contract with the negotiated transmission-bandwidth contract.

2. The method of claim 1, wherein the request for the additional transmission bandwidth comprises a request for a corresponding number of transmission credits, wherein one transmission credit corresponds to a predetermined amount of transmission bandwidth.

3. The method of claim 1, further comprising:
discarding, at the respective branch gateway device, traffic exceeding the upper bandwidth limit specified by the transmission-bandwidth contract to cause traffic loss at the respective branch gateway device;
in response to determining that the respective branch gateway device has experienced traffic loss for a predetermined duration, estimating an amount of additional transmission bandwidth needed to prevent the traffic loss; and
transmitting, by the respective branch gateway device to the VPN concentrator, a request for the estimated amount of additional transmission bandwidth.

4. The method of claim 3, wherein identifying one or more branch gateway devices with unused transmission bandwidth comprises identifying a minimum number of branch gateway devices that can provide the estimated amount of additional transmission bandwidth.

5. The method of claim 1,
wherein analyzing the traffic patterns comprises determining, for each branch gateway device, an average transmission bandwidth usage within a predetermined time window; and
wherein identifying the one or more branch gateway devices with unused transmission bandwidth comprises comparing the average transmission bandwidth usage of each branch gateway device with a corresponding transmission-bandwidth contract.

6. The method of claim 5, wherein a duration of the predetermined time window is between 30 minutes and one hour.

7. The method of claim 5, wherein the predetermined timer expires after a duration that is between 20% and 60% of a duration of the time window.

8. The method of claim 1, wherein the respective branch gateway device is coupled to the VPN concentrator via an Internet Protocol Security (IPSec)-based VPN tunnel.

9. The method of claim 8, wherein the request for additional transmission bandwidth comprises an IPSec Encapsulating Security Payload (ESP) probe request frame, and wherein a respective contract-update notification comprises an IPSec ESP probe response frame.

10. The method of claim 9, wherein the IPSec ESP probe request or response frame comprises a vendor-defined special opcode.

11. A branch gateway device coupled to a virtual private network (VPN) concentrator via a VPN tunnel, the branch gateway device comprising:
a tunnel-negotiation unit to negotiate, with the VPN concentrator, a transmission-bandwidth contract specifying an upper bandwidth limit for the branch gateway device to transmit data to the VPN concentrator via the VPN tunnel;
a traffic-analyzing unit to analyze traffic on the branch gateway device to determine whether additional transmission bandwidth is needed;
a bandwidth-request unit to, in response to the traffic-analyzing unit determining that additional transmission bandwidth is needed, send a request to the VPN concentrator for additional transmission bandwidth, wherein the request causes the VPN concentrator to analyze traffic patterns associated with a plurality of branch gateway devices coupled to the VPN concentrator to identify one or more branch gateway devices with unused transmission bandwidth and to allocate the requested additional transmission bandwidth to the branch gateway device by reducing transmission bandwidth allocated to the identified one or more branch gateway devices by an amount corresponding to the requested additional transmission bandwidth;
a contract-update unit to update the transmission-bandwidth contract in response to receiving a response from the VPN concentrator, thereby increasing the upper bandwidth limit; and
a timer, wherein expiration of the timer causes the contract-update unit to replace the updated transmission-bandwidth contract with the negotiated transmission-bandwidth contract, thereby revoking the additional transmission bandwidth allocated to the branch gateway device.

12. The branch gateway device of claim 11, wherein the request for the additional transmission bandwidth comprises a request for a corresponding number of transmission credits, wherein one transmission credit corresponds to a predetermined amount of transmission bandwidth.

13. The branch gateway device of claim 11, further comprising:
a contract-enforcing unit to discard traffic exceeding the upper bandwidth limit specified by the transmission-bandwidth contract to cause traffic loss;
wherein the traffic-analyzing unit is further to estimate an amount of additional transmission bandwidth needed to prevent the traffic loss, in response to determining that the branch gateway device has experienced traffic loss for a predetermined duration; and
wherein the bandwidth-request unit is to send a request to the VPN concentrator for the estimated amount of additional transmission bandwidth.

14. The branch gateway device of claim 13, wherein the request causes the VPN concentrator to identify a minimum number of branch gateway devices that can provide the estimated amount of additional transmission bandwidth.

15. The branch gateway device of claim 11,
wherein the request causes the VPN concentrator to determine, for each branch gateway device, an average transmission bandwidth usage within a predetermined time window.

16. The branch gateway device of claim 15, wherein the predetermined timer expires after a duration that is between 20% and 60% of a duration of the time window.

17. The branch gateway device of claim 11, wherein the VPN tunnel is an Internet Protocol Security (IPSec)-based VPN tunnel, and wherein the request for additional transmission bandwidth comprises an IPSec Encapsulating Security Payload (ESP) probe request frame.

18. A virtual private network (VPN) concentrator coupled to a plurality of branch gateway devices, the VPN concentrator comprising:
a tunnel-negotiation unit to negotiate, with a respective branch gateway device, a transmission-bandwidth contract for the respective branch gateway device, wherein the transmission-bandwidth contract specifies an upper bandwidth limit for the respective branch gateway device to transmit data to the VPN concentrator;
a request-receiving unit to receive, from the respective branch gateway device, a request for additional transmission bandwidth;
a traffic-analyzing unit to analyze traffic patterns associated with the plurality of branch gateway devices to identify one or more branch gateway devices with unused transmission bandwidth according to corresponding transmission-bandwidth contracts;
a bandwidth-allocation unit to allocate the requested additional transmission bandwidth to the respective branch gateway device by reducing transmission bandwidth allocated to the identified one or more branch gateway devices by an amount corresponding to the requested additional transmission bandwidth;
a contract-update-notification unit to transmit contract-update notifications to the respective branch gateway device and the identified one or more branch gateway devices to allow each branch gateway device to update a corresponding transmission-bandwidth contract, which comprises increasing the upper bandwidth limit at the respective branch gateway device while reducing the upper bandwidth limit at the identified one or more branch gateway devices; and
a timer, wherein expiration of the timer causes the respective branch gateway device to replace the updated transmission-bandwidth contract with the negotiated transmission-bandwidth contract to revoke the additional transmission bandwidth allocated to the respective branch gateway device.

19. The VPN concentrator of claim 18, wherein the traffic-analyzing unit is to:
determine, for each branch gateway device, an average transmission bandwidth usage within a predetermined time window; and
compare the average transmission bandwidth usage of each branch gateway device with a corresponding transmission-bandwidth contract.

20. The VPN concentrator of claim 19, wherein a duration of the predetermined time window is between 30 minutes and one hour.
